(19) United States
(12) Patent Application Publication
(10) Pub. No.: US 2024/0043003 A1
(43) Pub. Date: Feb. 8, 2024

(54) SYSTEMS AND METHODS FOR MANAGING ELECTRIC VEHICLE FOLLOWING DISTANCE

(71) Applicant: International Engine Intellectual Property Company, LLC, Lisle, IL (US)

(72) Inventors: James Thomas Beaucaire, Wheaton, IL (US); Paul Anton Wieshuber, Naperville, IL (US)

(21) Appl. No.: 17/881,297

(22) Filed: Aug. 4, 2022

(51) Int. Cl. B60W 30/16; B60W 40/076; B60W 40/11

(52) U.S. Cl. CPC B60W 30/16; B60W 40/076; B60W 40/11; B60W 2510/083; B60W 2420/52; B60W 2422/00; B60W 2520/16; B60W 2552/15; B60W 2554/80

(57) ABSTRACT

Disclosed herein are systems and methods, implementable in an electric vehicle equipped with adaptive cruise control, for maintaining in a subject vehicle substantially constant following distance relative to a preceding target vehicle where there has been a change in slope of a surface on which the subject vehicle is travelling and/or where pitch of the subject vehicle has changed. Systems and methods disclosed herein may maintain such substantially constant following distance by managing torque in the vehicle's electric motor. Such engine torque management effective for maintaining substantially constant following distance relative to a preceding target vehicle, notwithstanding change in driving surface slope and/or change in pitch of the subject vehicle, may be realized utilizing data received into the subject vehicle's vehicle control unit through sensors for detecting surface slope and sensors for detecting vehicle pitch, which may be located on the subject vehicle's frame.

### FIELD OF THE INVENTION

The present invention relates to systems and methods for managing the distance between a subject vehicle, with an adaptive cruise control feature activated, and a target vehicle preceding the subject vehicle. The present invention relates to systems and methods for managing vehicle following distance by managing the amount of torque requested in the subject vehicle.

### BACKGROUND

Conventional cruise control may be used to maintain a substantially constant vehicle speed that has been pre-set. Early forms of conventional cruise control maintained the substantially constant vehicle speed by adjusting throttle valve position using a cable. As technology progressed, cruise control systems began to operate electronically. In a vehicle containing a gasoline engine, the vehicle's electronic control unit (ECU) will send a command signal to modify throttle valve opening as necessary to maintain substantially constantly the pre-set vehicle speed. In a vehicle containing a diesel engine, the vehicle's ECU will send a command signal to adjust the amount of fuel being injected into the engine cylinders as necessary to maintain substantially constantly the pre-set vehicle speed. In an electric vehicle, the vehicle control unit (VCU) will adjust torque within the vehicle's motor as necessary to maintain substantially constantly the pre-set vehicle speed.

Conventional adaptive cruise control (ACC) likewise may be used to maintain a substantially constant vehicle speed. Conventional ACC additionally includes the ability to maintain a substantially constant following distance in a subject vehicle with ACC activated relative to a preceding target vehicle. Conventional ACC achieves this using a series of radar sensors that detect the target vehicle's speed and distance and modifying the subject vehicle's speed as necessary to maintain substantially constant following distance.

Thus, if the target vehicle decelerates, the ACC system, through the use of radar sensors, may detect such deceleration. In an electric vehicle, these radar sensors may communicate this deceleration to the subject vehicle's VCU.

As those of skill in the art will understand, torque is one factor that impacts vehicle speed. Torque, as the concept is applied to an electric vehicle motor, is the product of rotational force applied to the rotor multiplied by the distance through which that force travels.

When a subject vehicle containing an alternating current (AC) electric motor detects that a preceding target vehicle has decelerated, the VCU of such subject vehicle may transmit a command signal to the subject vehicle's inverter to modify the frequency and amplitude of current being emitted in such a manner so as to decrease the torque being applied to the rotor in the electric motor of the subject vehicle. Alternatively, when the subject vehicle detects that the target vehicle has switched to a different lane, or that conditions otherwise permit of acceleration, the VCU may then transmit a command signal to the inverter to modify the frequency and amplitude of current being emitted in such a manner so as to increase torque in the subject vehicle.

When a subject vehicle containing a direct current (DC) electric motor detects that a preceding target vehicle has decelerated, the VCU of such subject vehicle may adjust the voltage of the direct current being applied to the motor in such a manner so as to decrease the torque being applied to the rotor aspect of the motor. Alternatively, when the subject vehicle detects that the target vehicle has switched to a different lane, or that conditions otherwise permit of acceleration, the VCU may then adjust the voltage of the direct current being applied to the motor in such a manner so as to increase the torque being applied to the rotor aspect of the motor.

When a driver of an electric vehicle containing an AC electric motor modifies the amount of force being applied to the accelerator pedal or to the brake pedal, the VCU will determine a new desired torque value and will send a command signal requesting the new desired torque to the inverter. Alternatively, when a driver of an electric vehicle containing a DC electric motor modifies the amount of force being applied to the accelerator pedal or to the brake pedal, the VCU will determine a new desired torque value and will adjust the voltage of the direct current flowing to the motor accordingly.

When a driver of an electric vehicle modifies the amount of force being applied to the accelerator pedal or to the brake pedal, it is the programmable VCU that determines the extent of increase or decrease in torque that is requested.

Electric vehicles exhibit substantial absence of latency between when torque is requested to when such torque is effectuated in the motor. In an electric vehicle, a desired torque is realized substantially instantaneously once the VCU identifies such desired torque.

As discussed above, when ACC is active, there are instances when deceleration of the subject vehicle may be required in order to maintain a substantially constant following distance relative to the target vehicle. Different deceleration responses, however, may be required depending on, for example, the slope of the surface on which the subject vehicle is travelling. A vehicle travelling on a downward sloping surface may require a higher percent torque reduction in order to maintain substantially constant following distance than a vehicle travelling on a surface with a positive slope or on a flat or substantially flat surface because of acceleration due to gravity acting upon the subject vehicle when travelling on a downward sloping surface.

Similarly, different deceleration responses may be required of the ACC system depending on the pitch of the subject vehicle. A vehicle exhibiting a negative pitch may require a higher percent torque reduction than a vehicle exhibiting a positive pitch because of acceleration due to gravity acting upon the subject vehicle exhibiting a negative pitch.

Accordingly, information pertaining to slope of the surface on which the subject vehicle is travelling and information pertaining to pitch of the subject vehicle may inform identification of a new torque value necessary to maintain substantially constant following distance relative to a target vehicle.

In vehicles equipped with conventional ACC systems, in order to accurately adjust desired torque values given a downward sloping surface or a decrease in vehicle pitch (i.e., so as to maintain a substantially constant following distance behind a target vehicle), the system may not be requesting an optimal new desired torque value when travelling on an upward sloping surface or a substantially flat surface, or when vehicle pitch increases. This is because conventional ACC systems do not adequately control for factors such as change in slope of a surface and change in pitch of the subject vehicle. Rather, torque reduction models programmed into conventional ACC systems are calibrated based on a downward sloping environment and, therefore, may over-compensate with respect to torque reduction when the subject vehicle is travelling on an upward sloping or substantially flat surface, or when vehicle pitch increases.

### SUMMARY OF THE INVENTION

An aspect of this disclosure advantageously provides for a system, implementable in a subject electric vehicle equipped with adaptive cruise control technology, for maintaining a substantially constant following distance relative to a preceding target vehicle notwithstanding change in slope of a surface on which the subject vehicle is travelling. In an alternative embodiment, this disclosure advantageously provides for a system, implementable in a subject electric vehicle equipped with adaptive cruise control technology, for maintaining a substantially constant following distance relative to a preceding target vehicle notwithstanding change in pitch of the subject vehicle.

An aspect of this disclosure advantageously provides for such a system wherein, upon receipt of data from sensors on the subject vehicle for detecting driving surface slope and/or vehicle pitch, a vehicle control unit of the subject vehicle identifies a new desired torque value necessary to maintain a substantially constant following distance relative to a preceding target vehicle.

Systems of the present disclosure may comprise an electric motor comprising a rotor and a stator; a vehicle control unit; a first set of sensors connected to the vehicle control unit capable of detecting following distance relative to a preceding target vehicle and speed of the target vehicle; and a second set of sensors connected to the vehicle control unit capable of detecting driving surface slope. In an alternative embodiment, the second set of sensors may detect pitch of the subject vehicle.

Subject vehicles as contemplated herein may comprise either an AC or a DC electric motor. Where the subject vehicle comprises an AC motor, systems of the present disclosure may further comprise an inverter. According to such an embodiment, the VCU may transmit to the inverter a command signal requesting a new desired torque value as may be necessary to maintain substantially constant following distance relative to a preceding target vehicle.

Surface slope-detecting sensors and vehicle pitch-detecting sensors as described herein may be located in any number suitable locations on the subject vehicle including, without limitation, on the subject vehicle's frame.

An aspect of this disclosure advantageously provides for associated methods of operating a subject vehicle when ACC has been activated utilizing systems of the present disclosure so as to maintain substantially constant following distance relative to a preceding target vehicle.

### BRIEF DESCRIPTION OF THE DRAWINGS

FIG. 1 depicts a left side view of a vehicle that is travelling on a substantially flat surface and is equipped with sensors for determining slope of the surface, as contemplated by systems and methods of the present invention.

FIG. 2 depicts a left side view of a vehicle that is travelling on an upward sloping surface and is equipped with sensors for determining slope of the surface, as contemplated by systems and methods of the present invention.

FIG. 3 depicts a left side view of a vehicle that is travelling on a downward sloping surface and is equipped with sensors for determining slope of the surface, as contemplated by systems and methods of the present invention.

FIG. 4 is a flow chart depicting steps of methods according to the present disclosure.

### DETAILED DESCRIPTION

The following disclosure concerns systems and methods, implementable in electric vehicles equipped with ACC, where the ACC feature is activated, for managing vehicle following distance by managing torque and torque reduction in a subject vehicle. Skilled artisans will appreciate additional embodiments of systems and methods of the present disclosure that extend beyond the examples of this disclosure.

When reading this disclosure, singular forms should be read to contemplate and disclose plural alternatives. Similarly plural forms should be read to contemplate and disclose singular alternatives. Conjunctions should be read as inclusive unless stated otherwise.

Expressions such as “at least one of A, B, and C” should be read to permit any one of A, B, or C, alone or in combination with the remaining elements. Additionally, such groups may include multiple instances of one or more elements in that group, which may be included with other elements of that group. All numbers, measurements, and values are given as approximations unless expressly stated otherwise.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or from technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings.

For purposes of clearly describing the components, features, and method steps discussed throughout this disclosure, some frequently used terms will now be defined. The term “subject vehicle,” as it is used throughout this disclosure, shall mean an electric vehicle, equipped with ACC and operating with ACC activated, comprising a system of the present disclosure and/or operating according to a method of the present disclosure. Such subject vehicles should be understood to include substantially all components that modern electric vehicles possess. Those skilled in the art will readily appreciate the identify of such components. Such components may include, without limitation, a battery pack, a battery management system, an electric motor, an inverter (where the motor is an AC motor), and a charging port. The term “target vehicle,” as it is used throughout this disclosure, shall mean a vehicle located some distance in front of a subject vehicle and with respect to which speed of the subject vehicle is calibrated so as to maintain substantially constant following distance. The term “electric motor,” as it is used throughout this disclosure, is intended to include both alternating current (AC) and direct current (DC) electric vehicle motors, unless otherwise indicated. The term “electric motor” should be understood to include all components typically found in modern electric vehicle AC or DC motors, as applicable. Those skilled in the art will readily appreciate the identify of such components. Such components may include, among others, a rotor, a shaft, and a stator.

Various aspects of the disclosure will now be described in detail, without limitation. In the following disclosure, systems and methods for controlling vehicle following distance by managing torque and torque reduction in a subject vehicle, will be discussed. Those of skill in the art will appreciate that alternative labeling of the components, features, and method steps may be provided, which is consistent with the scope and spirit of this disclosure. Skilled readers should not view inclusion of any alternative labels as limiting in any way.

ACC systems are commonly found in many different makes and models of vehicles today. ACC systems in a subject vehicle may be utilized to maintain a substantially constant following distance behind a preceding target vehicle located in front of the subject vehicle. When a vehicle with a conventional ACC system activated is travelling on a downward sloping surface, the ACC system may decrease the desired torque value to off-set acceleration due to gravity caused by the downward slope of the surface. Such off-set may be necessary to maintain a substantially constant following distance relative to a target vehicle given the increase in speed due to the downward sloping surface. Such decreased desired torque may be communicated to the VCU. The VCU may then, in an electric vehicle comprising an AC motor, communicate the new desired torque to the inverter. The inverter may then effectuate the new desired torque by modifying the frequency and amplitude of the alternating current applied to the rotor. In an electric vehicle comprising a DC motor, the VCU may effectuate the new desired torque by modifying the voltage of the direct current being applied to the rotor.

Conventional ACC systems, when there is a change in slope of the surface on which the subject vehicle is travelling, request a new desired torque that is calibrated to a downward slope. This new requested torque is, therefore, not optimal for upward sloping and substantially flat surfaces. Systems and methods of the present disclosure solve this problem by utilizing sensors that are communicatively and operatively connected to the VCU and transmit data to the VCU regarding slope of the surface on which the subject vehicle is travelling. With this information regarding slope of the surface, a more appropriate new desired torque may be identified by the VCU when there is a change in slope of the driving surface.

In an alternative embodiment, systems and methods of the present disclosure comprise a series of sensors that detect pitch of a subject vehicle. When vehicle pitch changes, a new desired torque will be identified to off-set forces causing the change in pitch. With this information regarding pitch of the subject vehicle, a more appropriate new desired torque may be identified by the VCU when there is a change in pitch than with conventional ACC systems.

Systems and methods of the present disclosure may be utilized in a subject vehicle. Systems and methods of the present disclosure may be utilized to maintain a substantially constant following distance behind a target vehicle.

Components of systems of the present disclosure may include, without limitation, an electric motor. Such electric motor may be an AC motor or a DC motor. Where the electric motor is an AC motor, the electric motor may further comprise an inverter.

Components of systems of the present disclosure may include, without limitation, a VCU.

Components of systems of the present disclosure may include, without limitation, radar sensors capable of detecting following distance relative to a target vehicle and capable of detecting speed of the target vehicle. Such sensors may be communicatively and operatively connected to the VCU. Those of skill in the art will readily appreciate suitable locations throughout the subject vehicle for placement of such radar sensors. Without limitation, such radar sensors may be located behind the grill of a subject vehicle.

Components of systems of the present disclosure may include, without limitation, sensors that are capable of detecting slope of the surface on which the subject vehicle is travelling. Such sensors may be communicatively and operatively connected to the VCU. Such sensors may be located throughout the subject vehicle at any position that is substantially stable when the subject vehicle is being driven. Without limitation, such sensors may be located on a vehicle's frame within approximately six inches from such vehicle's wheel well. Those of skill in the art will readily appreciate alternative suitable locations for placement of the slope-detecting sensors and pitch-detecting sensors discussed herein.

Systems of the present disclosure, as well as related methods of the present disclosure, are intended to operate in electric vehicles equipped with ACC when such ACC has been activated.

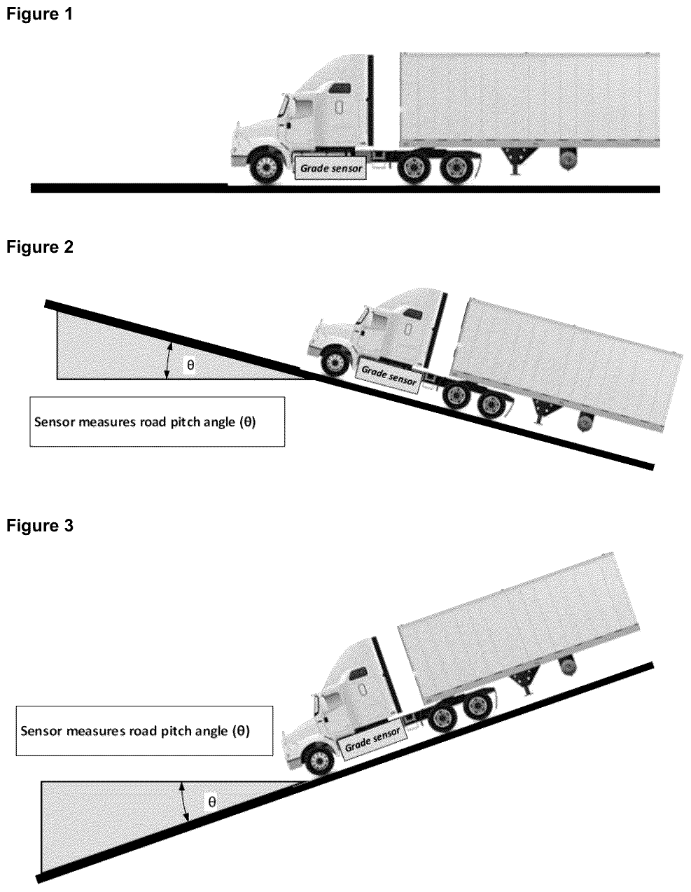

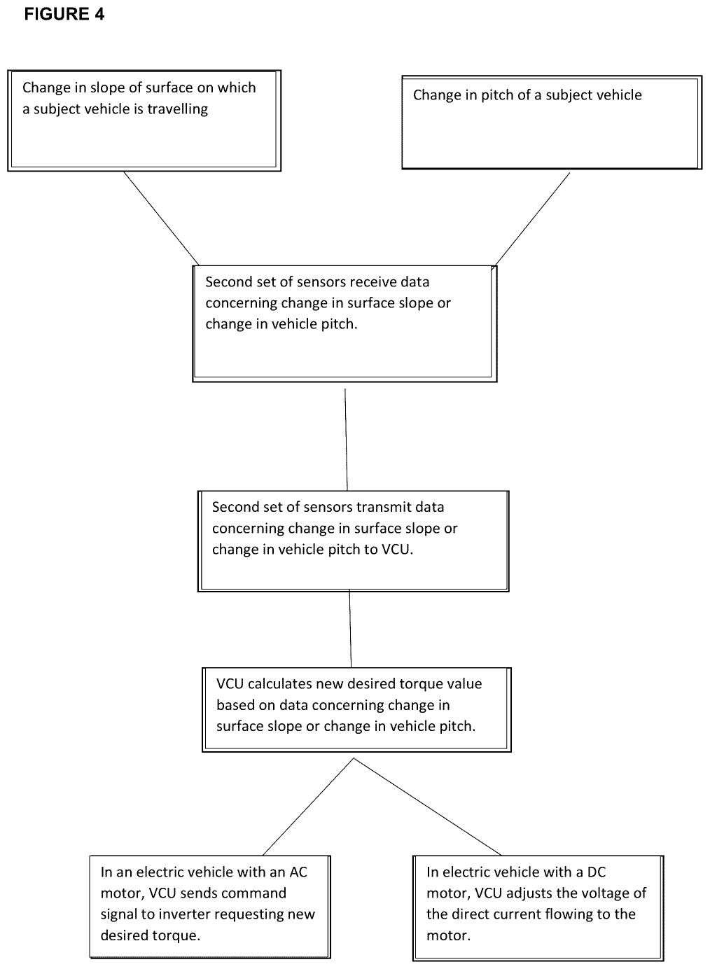

According to systems and methods of the present disclosure, and referring to FIGS. 1-3, when a subject vehicle encounters a change in slope of the surface on which it is travelling, sensors transmit a signal to the VCU communicating data regarding the change in slope of the surface. Based on the data concerning change in road slope received from such sensors, the VCU may calculate a new desired torque value necessary to maintain substantially constant following distance relative to a target vehicle.

Upon receipt by the VCU of such road slope data, in vehicles containing an AC electric motor, the VCU, according to systems and methods of the present disclosure, may calculate a new desired torque value and may output this new desired torque value to the inverter. Modifications to the frequency and/or amplitude of the AC current emitted by the inverter may be effectuated in order to achieve the new desired torque value. Such new torque value may be necessary in order to maintain a substantially constant following distance relative to a target vehicle where there has been a change in slope of the surface on which the subject vehicle is travelling. Where the subject vehicle comprises a DC electric motor, the VCU may transmit a command signal adjusting the voltage of the direct current to the rotor in order to modify torque to maintain a substantially constant following distance relative to a target vehicle where there has been a change in slope of the surface on which the subject vehicle is travelling.

In an alternative embodiment, systems of the present disclosure may comprise sensors capable of detecting pitch of the subject vehicle in lieu of or in addition to sensors for detecting slope of a surface on which the subject vehicle is travelling.

According to such embodiment, when pitch of the subject vehicle changes, sensors located on the subject vehicle transmit a signal to the VCU communicating data concerning the change in vehicle pitch. Such sensors may be located at any position on the subject vehicle that preserves effectiveness of the sensors. Without limitation, such sensors may be positioned as reflected in FIGS. 1-3. According to aspects of systems enabled by this disclosure, pitch-detecting sensors as discussed herein may be positioned, without limitation, on a vehicle's frame within approximately six inches from such vehicle's wheel well. Those of skill in the art will readily appreciate alternative suitable locations for placement of such sensors.

Based on the data concerning change in vehicle pitch, the VCU may calculate a new desired torque value necessary to maintain substantially constant following distance relative to a target vehicle.

Upon receipt by the VCU of such vehicle pitch data, in vehicles containing an AC electric motor, the VCU, according to systems and methods of the present disclosure, may calculate a new desired torque value and may output this new desired torque value to the inverter. Modifications to the frequency and/or amplitude of the AC current emitted by the inverter may be effectuated in order to achieve the new desired torque value. Such new torque value may be necessary in order to maintain a substantially constant following distance relative to a target vehicle where there has been a change in vehicle pitch. Where the subject vehicle comprises a DC electric motor, the VCU may transmit a command signal adjusting the voltage of the direct current to the rotor in order to modify torque to maintain a substantially constant following distance relative to a target vehicle where there has been a change in vehicle pitch.

While various aspects of systems and methods enabled by this disclosure have been described above, the description of this disclosure is intended to illustrate and not limit the scope of the invention. The invention is defined by the scope of the claims and not the illustrations and examples provided in the above disclosure. Skilled artisans will appreciate additional aspects of the systems and methods enabled by this disclosure, which may be realized in alternative embodiments, after having the benefit of the above disclosure. Other aspects, advantages, embodiments, and modifications are within the scope of the claims.

1. A system, implementable in a subject vehicle equipped with adaptive cruise control technology, for maintaining a substantially constant following distance from a target vehicle comprising:
(a) an electric motor comprising a rotor and a stator;
(b) a vehicle control unit;
(c) a first set of sensors communicatively and operatively connected to the vehicle control unit, wherein said sensors are capable of detecting following distance relative to the target vehicle and the speed of the target vehicle;
(d) a second set of sensors communicatively and operatively connected to the vehicle control unit, wherein said sensors are capable of detecting slope of a surface on which the subject vehicle is travelling;
wherein, when the subject vehicle encounters a change in slope of a surface on which it is travelling, the second set of sensors transmits a signal to the vehicle control unit communicating data concerning the change in slope of the surface;
wherein the vehicle control unit, based on the data concerning change in slope received from the second set of sensors, calculates a new desired torque value necessary to maintain substantially constant following distance relative to a target vehicle; and
wherein the vehicle control unit adjusts torque to match the new desired torque value.

2. The system of claim 1, wherein the second set of sensors are located on the frame of the subject vehicle.

3. The system of claim 1, wherein the electric motor is a DC electric motor.

4. The system of claim 1, wherein the electric motor is an AC electric motor and wherein the subject vehicle further comprises an inverter.

5. The system of claim 4 wherein the vehicle control unit adjusts torque by sending a command signal to the inverter requesting that torque be set to match the new desired torque value.

6. A system, implementable in a subject vehicle equipped with adaptive cruise control technology, for maintaining a substantially constant following distance from a target vehicle comprising:
(a) an electric motor, wherein the electric motor comprises a rotor and a stator;
(b) a vehicle control unit;
(c) a first set of sensors communicatively and operatively connected to the vehicle control unit, wherein said sensors are capable of detecting following distance relative to the target vehicle and the speed of the target vehicle;
(d) a second set of sensors communicatively and operatively connected to the vehicle control unit, wherein said sensors are capable of detecting pitch of the subject vehicle;
wherein, when the pitch of the subject vehicle changes, the second set of sensors transmit a signal to the vehicle control unit communicating the change in vehicle pitch;
wherein the vehicle control unit, based on the data concerning change in vehicle pitch received from the second set of sensors, calculates a new desired torque value necessary to maintain substantially constant following distance relative to the target vehicle; and
wherein the vehicle control unit adjusts torque to match the new desired torque value.

7. The system of claim 6, wherein the second set of sensors are located on the frame of the subject vehicle.

8. The system of claim 6, wherein the electric motor is DC electric motor.

9. The system of claim 6, wherein the electric motor is an AC electric motor and wherein the subject vehicle further comprises an inverter.

10. The system of claim 9 wherein the vehicle control unit adjusts torque by sending a command signal to the inverter requesting that torque be set to match the new desired torque value.

11. A method, implementable in a subject vehicle equipped with adaptive cruise control technology, for maintaining a substantially constant following distance relative to a preceding target vehicle comprising:
(a) providing an electric motor, wherein the electric motor comprises a rotor and a stator;
(b) providing a vehicle control unit;
(c) providing a first set of sensors communicatively and operatively connected to the vehicle control unit, wherein said sensors are capable of detecting following distance relative to the target vehicle and the speed of the target vehicle;
(d) providing a second set of sensors communicatively and operatively connected to the vehicle control unit, wherein said sensors are capable of detecting slope of the surface on which the subject vehicle is travelling; and
(e) activating adaptive cruise control in the subject vehicle;
wherein, when the subject vehicle encounters a change in slope of the surface on which it is travelling, the second set of sensors transmits a signal to the vehicle control unit communicating data concerning the change in slope of the surface;
wherein the vehicle control unit, based on the data concerning change in slope received from the second set of sensors, calculates a new desired torque value necessary to maintain substantially constant following distance relative to a target vehicle; and
wherein the vehicle control unit adjusts torque to match the new desired torque value.

12. The method of claim 11, wherein the second set of sensors are located on the frame of the subject vehicle.

13. The method of claim 11, wherein the electric motor is a DC electric motor.

14. The method of claim 11, wherein the electric motor is an AC electric motor and wherein the subject vehicle further comprises an inverter.

15. The method of claim 14 wherein the vehicle control unit adjusts torque by sending a command signal to the inverter requesting that torque be set to match the new desired torque value.

16. A method, implementable in a subject vehicle equipped with adaptive cruise control technology, for maintaining a substantially constant following distance relative to a preceding target vehicle comprising:
(a) providing an electric motor, wherein the electric motor comprises a rotor and a stator;
(b) providing a vehicle control unit;
(c) providing a first set of sensors communicatively and operatively connected to the vehicle control unit, wherein said sensors are capable of detecting following distance relative to the target vehicle and the speed of the target vehicle;
(d) providing a second set of sensors communicatively and operatively connected to the vehicle control unit, wherein said sensors are capable of detecting pitch of the subject vehicle; and
(e) activating adaptive cruise control in the subject vehicle;
wherein, when the pitch of the subject vehicle changes, the second set of sensors transmit a signal to the vehicle control unit communicating the change in vehicle pitch;
wherein the vehicle control unit, based on the data concerning change in vehicle pitch received from the second set of sensors, calculates a new desired torque value necessary to maintain substantially constant following distance relative to the target vehicle; and
wherein the vehicle control unit adjusts torque to match the new desired torque value.

17. The method of claim 16, wherein the second set of sensors are located on the frame of the subject vehicle.

18. The method of claim 16, wherein the electric motor is a DC electric motor.

19. The method of claim 16, wherein the electric motor is an AC electric motor and wherein the subject vehicle further comprises an inverter.

20. The method of claim 19 wherein the vehicle control unit adjusts torque by sending a command signal to the inverter requesting that torque be set to match the new desired torque value.
